(19) United States
(12) Patent Application Publication
(10) Pub. No.: US 2010/0133972 A1
(43) Pub. Date: Jun. 3, 2010

(54) Connector

(76) Inventors: Ceferino Garcia, Juarez Chihuahua (MX); Martha Menchaca, Juarez Chihuahua (MX)

Correspondence Address: OSRAM SYLVANIA INC, 100 ENDICOTT STREET, DANVERS, MA, 01923, US

(21) Appl. No.: 12/315,347

(22) Filed: Dec. 2, 2008

(51) Int. Cl. H01J 61/52; H01J 5/54

(52) U.S. Cl. 313/46; 439/617

(57) ABSTRACT

A lamp (10) includes an integral cooling system (12) and comprises: a quartz envelope (14) including a light-source (16) operating at a temperature above 900° C. A seal (18) closes one end of the quartz envelope and includes electrical lead-ins (20, 2) for electrical connection to the light-source (16). A ceramic base (24) is affixed to the seal (18) on only two sides (26, 28) thereof. The base (24) includes a circumferential bottom (30) with upstanding walls (44, 46) and includes a pair of contacts (32, 34) connected to the lead-ins (20, 22); and an air passage (36) between the circumferential bottom (30) and the seal (18).

### TECHNICAL FIELD

This invention relates to lamps and particularly to lamps that operate at high temperatures. More particularly, it relates to a lamp including a base characterized by integral cooling.

### BACKGROUND ART

High temperature lamps, i.e., lamps operating in ranges approaching 1000° C., require bases formed of a material that can withstand the operating temperatures. Such materials comprise ceramic materials as opposed to the plastic materials employed with lamps operating at lesser temperature. A favored ceramic material is steatite. While this material works well, by its very nature it has heat insulating properties that often deleteriously raises the temperature of the seal area of the lamp fitted therein, causing the seal to crack and fail. Also, often, the high temperature of the seal area can cause fuse failure or oxidation at the lead-wire welder points.

### DISCLOSURE OF INVENTION

It is, therefore, an object of the invention to obviate the disadvantages of the prior art.

It is another object of the invention to enhance the cooling of high temperature lamps.

Yet another object of the invention is the improvement of bases for high temperature lamps.

These objects are accomplished, in one aspect of the invention, by the provision of a lamp including an integral cooling system comprising: a quartz envelope including a light-source operating at a temperature above 900° C.; a seal at one end of the quartz envelope including electrical lead-ins for electrical connection to the light-source; a ceramic base affixed to the seal on only two sides thereof, the base including a circumferential bottom including a pair of contacts connected to the lead-ins; and an air passage between the circumferential bottom and the seal. The air passage reduces the temperature in the seal area in the range of 50%, greatly increasing the life of the lamp.

### BRIEF DESCRIPTION OF THE DRAWINGS

FIG. 1 is an elevation view of a prior art lamp.

FIG. 2 is an elevation view of an embodiment of the invention;

FIG. 3 is a perspective view of a base in accordance with an aspect of the invention;

FIG. 4 is a plan view thereof; and

FIG. 5 is a side elevation view thereof.

### BEST MODE FOR CARRYING OUT THE INVENTION

For a better understanding of the present invention, together with other and further objects, advantages and capabilities thereof, reference is made to the following disclosure and appended claims taken in conjunction with the above-described drawings.

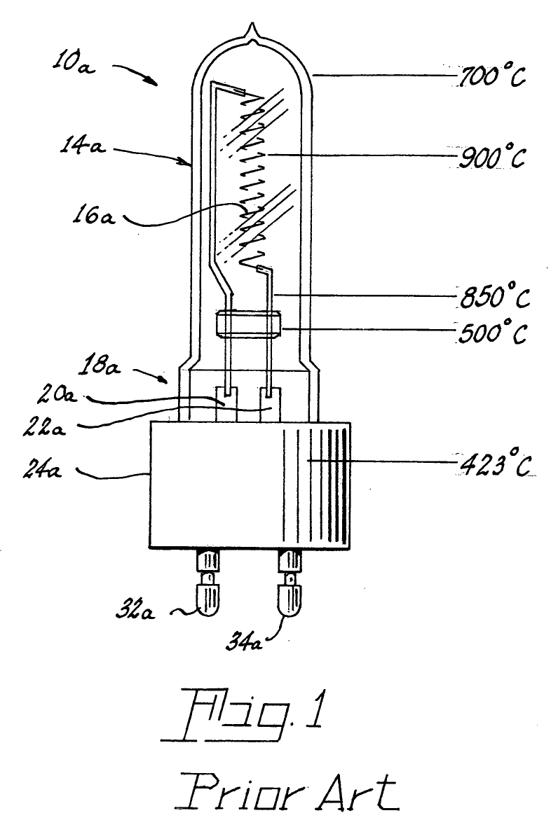

Referring now to the drawings with greater particularity, there is shown in FIG. 1 a prior art lamp 10a having a quartz envelope 14a including a light-source 16a operating at a temperature above 900° C. A seal 18a, for example, a press seal, closes one end of the quartz envelope and includes electrical lead-ins 20a, 22a for electrical connection to the light-source 16a. A cylindrical ceramic base 24a surrounds the seal 18a and includes a pair of contacts 32a, 34a connected to the lead-ins 20a, 22a. The right side of the illustration depicts the various temperature ranges encountered during the operation of the lamp and of particular concern with instant invention is the 423° C. that occurs within the inside of the base 24a. Cooling of this area has been difficult and results in the aforementioned failures caused by cracking of the seal, allowing air to enter and destroying the lamp.

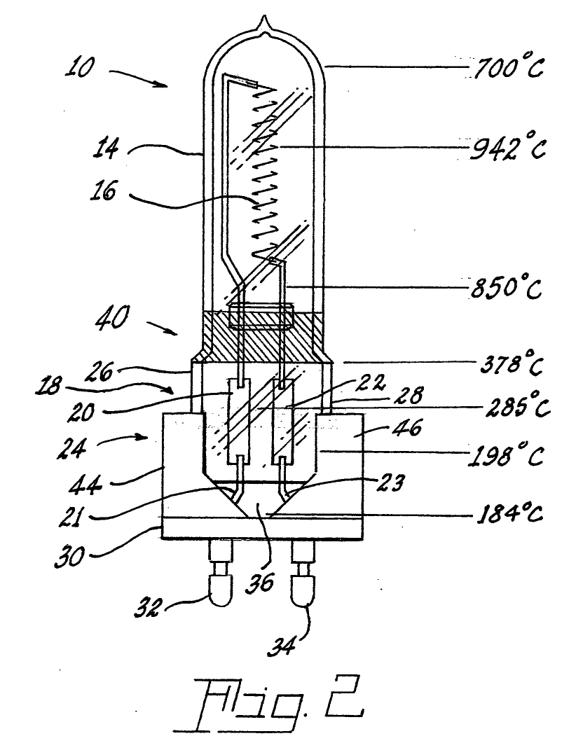

To obviate the problem the lamp illustrated in FIG. 2 is provided. Herein, a lamp 10 includes an integral cooling system 12. The lamp 10 comprises a quartz envelope 14 including a light-source 16, for example, a coiled coil incandescent filament, operating at a temperature above 900° C. A seal 18, for example, a press seal, is located at one end of the quartz envelope and includes electrical lead-ins 20, 22 for electrical connection to the light-source 16. In this instance, a ceramic base 24 with upstanding walls 44, 46 is affixed to the seal 18 on only two sides 26, 28 thereof (the press seal being substantially rectangular in cross-section). The base 24 includes a circumferential bottom 30 that has a pair of contacts 32, 34 connected to the lead-ins 20, 22, for example, by leads 21, 23. and an air passage 36 between the circumferential bottom 30 and the seal 18.

The lamp 10 includes an area 40 above the seal 18 and above the ceramic base that is covered by a heat and light insulating paint 42 such, for example, a layer of zinc oxide.

As can be seen from the temperature ranges illustrated with the lamp of the invention (FIG. 2), the temperature ranges are drastically reduced from those of the prior art, beginning with the painted area 40 down to the air passage 36, where a temperature of 184° C. is recorded.

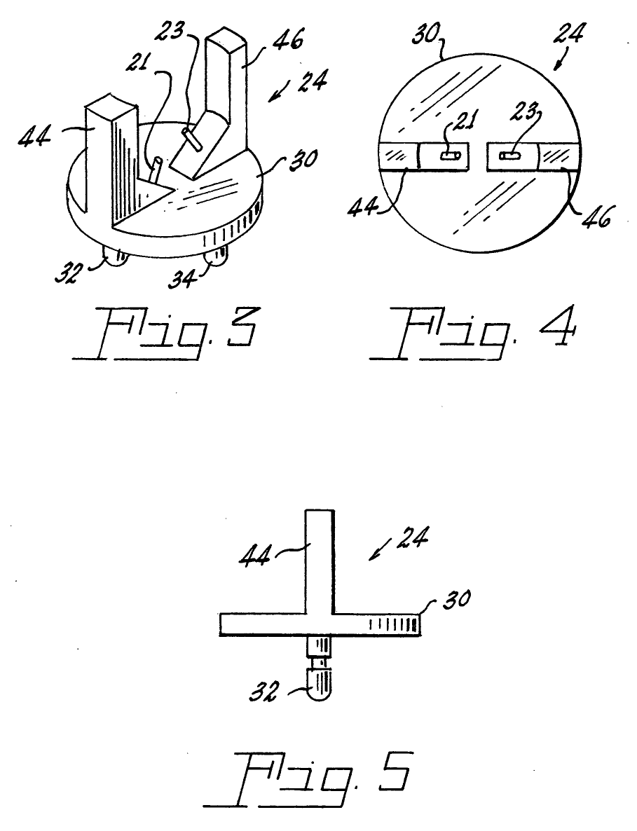

The base 24 is more particularly illustrated in FIGS. 3-5 and is constructed from a high temperature ceramic material, such as steatite or an alumina ceramic.

While there have been shown and described what are at present considered to be the preferred embodiments of the invention, it will be apparent to those skilled in the art that various changes and modifications can be made herein without departing from the scope of the invention as defined by the appended claims.

What is claimed is:

1. A lamp including an integral cooling system comprising:
a quartz envelope including a light-source operating at a temperature above 900° C.;
a seal at one end of said quartz envelope including electrical lead-ins for electrical connection to said light-source;
a ceramic base affixed to said seal on only two sides thereof, said base including a circumferential bottom including a pair of contacts connected to said lead-ins; and
an air passage between said circumferential bottom and said seal.

2. The lamp of claim 1 wherein said light-source is a tungsten filament.

3. The lamp of claim 2 wherein said quartz envelope includes an area above said seal and above said ceramic base and said area is covered by a heat and light insulating paint.

4. The lamp of claim 3 wherein said paint comprises zinc oxide.

5. A base for a high temperature lamp comprising:
a circumferential bottom; and
oppositely disposed walls extending upwardly from said circumferential bottom, said walls having a thickness less than the diameter of the circumferential wall and defining a space therebetween for receiving the sides of a seal of said lamp.
